(19) United States
(12) Patent Application Publication
(10) Pub. No.: US 2007/0218303 A1
(43) Pub. Date: Sep. 20, 2007

(54) Aluminum alloy-made part

(75) Inventors: Junpei Ogawa, Tokyo (JP); Takahiro Hamada, Yokohama-shi (JP); Tomonori Miyazawa, Chigasaki-shi (JP); Toyoki Iguchi, Yokohama-shi (JP); Takuma Suzuki, Yokohama-shi (JP); Kouji Yamaguchi, Kyoto-shi (JP)

Correspondence Address: FOLEY AND LARDNER LLP;SUITE 500, 3000 K STREET NW, WASHINGTON, DC, 20007, US

(73) Assignees: NISSAN MOTOR CO., LTD.; NIHON ALUMINA KAKOU CO., LTD.

(21) Appl. No.: 11/723,281

(22) Filed: Mar. 19, 2007

(30) Foreign Application Priority Data
Mar. 20, 2006 (JP) 2006-077652
Mar. 20, 2006 (JP) 2006-077673
Dec. 20, 2006 (JP) 2006-342902

(51) Int. Cl. B32B 15/04

(52) U.S. Cl. 428/472.2

(57) ABSTRACT

An aluminum alloy-made part of the present invention includes an aluminum alloy, and an anodic oxide coating which coats a surface of the aluminum alloy and contains at least one of silver and copper. The aluminum alloy-made part is capable of enhancing the heat conduction performance in the interface between the anodic oxide coating and the base material and the heat radiation performance on the surface of the part concerned, thereby making it possible to make the heat resistance and the adhesion resistance compatible with good beat conductivity and good heat radiation property.

### BACKGROUND OF THE INVENTION

1. Field of the Invention

The present invention relates to an aluminum alloy-made part which includes an anodic oxide coating on a predetermined region and is suitably used for a valve, a piston, a cylinder block, or the like in an internal combustion engine such as an automotive engine.

2. Description of the Related Art

To an aluminum alloy-made part for use in an internal combustion engine such as an automotive engine, an anodizing for hard anodic oxide coating is applied for the purpose of enhancement of heat crack resistance and adhesion resistance of the part concerned.

For example, to a piston for a diesel engine as the internal combustion engine, which is used after implementing the T6 treatment mainly for the AC8A material (Al—Si—Cu—Ni—Mg alloy cast material), the anodizing is widely applied for the purpose of taking countermeasures against a crack of a lip of a piston cavity. Moreover, to a piston for a gasoline engine, the anodizing is widely applied for the purpose of preventing adhesion of a piston ring groove at a high temperature. The anodizing is inexpensive and highly capable of dealing with mass production of the part concerned.

The anodizing implemented as described above for the purpose of the enhancement of the heat crack resistance and the adhesion resistance enhances heat radiation performance of a surface of such a treatment target as the piston. On the other hand, an anodic oxide coating thus formed has lower heat conductivity than an aluminum alloy as a base material, a heat barrier layer is generated on an interface between the base material and the anodic oxide coating, and accordingly, there is a harmful effect that a flow of heat is deteriorated.

In this connection, Japanese Patent Laid-Open Publication No. S63-289370 proposes that an anodizing is to be implemented for an upper end surface of the piston, or the like. This publication declares that, in such a way, an effect of reducing a heat loss, which results from nontransmission of heat from a combustion chamber to the piston, is obtained.

An intake valve in the internal combustion engine allows and blocks communication between the combustion chamber and an intake manifold supplied with fuel. The intake valve has functions, when the communication is blocked, to promote evaporation of the supplied fuel by heat owned by the intake valve itself, to assist a smooth intake of the fuel, and to thereby turn the fuel into an easily combustible state. Moreover, the intake valve decreases an intake temperature by purging heat from the combustion chamber by using latent heat of evaporation in order to promote the evaporation of the fuel.

Heretofore, for the intake valve for the internal combustion engine, which is as described above, heat resistant steels of SUH-1, 3, 4 and 11 defined in JIS G 4311 have been used placing importance on heat resistance (oxidation resistance at the high temperature) and fatigue strength (refer to Japanese Patent Laid-Open Publication No. H10-81902).

Moreover, in recent years, an attempt has been made, which is to reduce an inertial weight of the intake valve, to reduce a loss during an operation thereof, and to thereby enhance engine performance (refer to Japanese Patent Laid-Open Publication No. H8-144722).

### SUMMARY OF THE INVENTION

In the internal combustion engine, an outflow of the heat to the piston is reduced owing to such a heat insulation effect by the anodizing. However, the heat remains on the anodic oxide coating on the surface of the piston, and the intake temperature thereby rises. This deteriorates knocking resistance, resulting in an occurrence of a problem that combustion efficiency is not improved.

Moreover, for other aluminum parts applied to the internal combustion engine as described above, good heat conductivity and good heat radiation property are required as well as the heat resistance and the adhesion resistance in order to enhance the combustion efficiency.

Specifically, in a heat resistant steel-made intake valve placing importance on the oxidation resistance and the fatigue resistance at the high temperature, and a titanium alloy-made intake valve placing importance on weight reduction, which are described in Japanese Patent Laid-Open Publication Nos. H10-81902 and H8-144722, heat conductivities thereof are as low as approximately 25 W/m/K and approximately 8 W/m/K, respectively. Therefore, it is difficult for the heat to be dissipated from the intake valve, causing a problem that it is difficult to obtain effects of improving the knocking resistance, saving fuel consumption, and improving an output of the internal combustion engine. These effects are brought by decreasing the temperature of the combustion chamber. Hence, it is considered to use, as the material of the intake vale, an aluminum alloy which is excellent in heat conduction.

However, thermal emissivity of a forged surface of the aluminum alloy-made intake valve is lower as compared with that of a forged surface of the intake valve made of usual heat resistant steel. Specifically, while the thermal emissivity of the oxidized surface of the steel is approximately 0.6, the thermal emissivity of the surface of the aluminum is 0.1 or less. Therefore, though the material of the intake valve itself has excellent heat conductivity, and the heat conduction from a front of a valve umbrella (umbrella front) to a back thereof (umbrella back) is good, there is a problem that heat reception (heat absorption) from an inside of the combustion chamber, which is performed through the umbrella front, and heat radiation to the fuel, which is performed through the umbrella back, are little.

The present invention has been made focusing on the above-described problems regarding the heat conductivity and the heat radiation property in the conventional aluminum alloy-made part such as the piston and the intake valve for the internal combustion engine. It is an object of the present invention to provide an aluminum alloy-made part capable of enhancing the heat conduction performance in the interface between the anodic oxide coating and the base material and the heat radiation performance on the surface of the part concerned, of both of which lowness is problematic in the heat conduction though the part concerned is formed of an aluminum alloy which is excellent in heat conduction, thereby making it possible to make the heat resistance and the adhesion resistance compatible with good heat conductivity and good heat radiation property.

According to one aspect of the present invention, there is provided an aluminum alloy-made part comprising: an aluminum alloy; and an anodic oxide coating which coats a surface of the aluminum alloy and contains at least one of silver and copper.

### BRIEF DESCRIPTION OF THE DRAWINGS

The invention will now be described with reference to the accompanying drawings wherein;

FIG. 1 is a schematic cross-sectional view showing a structure of an anodic oxide coating of the present invention;

FIG. 2A is a cross-sectional view showing a structure of a piston for a diesel engine;

FIG. 2B is a plan view showing the piston of FIG. 2A;

FIG. 2C is a cross-sectional view showing a structure of a piston for a gasoline engine;

FIG. 3 is a perspective view showing a structure of an intake valve for an internal combustion engine;

FIG. 4A is a conceptual view showing a status where heat is radiated through an intake valve on which an anodic oxide coating of the present invention is not provided;

FIG. 4B is a conceptual view showing a status where the heat is radiated through an intake valve on which the anodic oxide coating of the present invention is provided;

FIG. 5 is a graph showing a relationship between a fuel consumption improvement ratio and a silver content in the anodic oxide coating in Example 1;

FIG. 6 is a graph showing a relationship between a peel strength of the anodic oxide coating and the silver content in the anodic oxide coating in Example 1;

FIG. 7 is a graph showing relationships between regions where the anodic oxide coatings are formed and the fuel consumption improvement ratio in Example 2;

FIG. 8 is a graph showing relationships between the fuel consumption improvement ratio and area ratios of the anodic oxide coatings of a piston top and a piston top back in Example 3;

FIG. 9 is a graph showing relationships between the fuel consumption improvement ratio and average thermal emissivities of an umbrella front and an umbrella back in Example 4;

FIG. 10 is a graph showing relationships between a fuel evaporation rate and the average thermal emissivities of the umbrella front and the umbrella back in Example 4;

FIG. 11 is a graph showing relationships between the fuel consumption improvement ratio and the average thermal emissivities of the umbrella front and the umbrella back in Example 5;

FIG. 12 is a graph showing relationships between a temperature of a center of a cylinder head and the average thermal emissivities of the umbrella front and the umbrella back in Example 5;

FIG. 13 is a graph showing relationships between the fuel consumption improvement ratio and the silver content in the anodic oxide coatings in Example 6;

FIG. 14 is a graph showing an effect of the anodic oxide coating to an abrasion amount of a shaft end in Example 7;

FIG. 15 is a graph showing an effect of the anodic oxide coating to an abrasion amount of a valve face in Example 7;

FIG. 16 is a graph showing an effect of the anodic oxide coating to an abrasion amount of a stem in Example 7;

FIG. 17 is a graph showing an effect of the anodic oxide coating to an abrasion amount of a cotter groove in Example 7; and

FIG. 18 is a graph showing an effect of removing a growth layer of the anodic oxide coating to an abrasion amount of the valve face in Example 8.

### DETAILED DESCRIPTION OF THE PREFERRED EMBODIMENT

Hereinafter, description will be made of embodiments of the present invention with reference to the drawings.

An aluminum alloy-made part of the present invention includes an anodic oxide coating on a predetermined region. Then, the anodic oxide coating contains silver (Ag) or copper (Cu), or both thereof. The aluminum alloy-made part including the anodic oxide coating can be applied, for example, to an engine part such as a piston, intake/exhaust valves, a cylinder head, a cylinder block, a compressor housing, piston rings, and an oil pan.

In the present invention, in order to form the anodic oxide coating as described above, which contains silver and/or copper, an electrolysis solution made of sulfuric acid, oxalic acid, or the like, which is made to contain copper ions and/or silver ions by being added with copper nitrate, copper sulfate, silver nitrate, silver sulfate, and the like, just needs to be used in the case of an anodizing according to the art.

It is desirable that a concentration of silver and/or copper in the electrolysis solution in this case be set at approximately 10 to 30 g/L. A content of silver and/or copper in the anodic oxide coating can be adjusted by increasing or reducing the concentration of these metals in the electrolysis solution, and a treatment time and a condition of the anodizing.

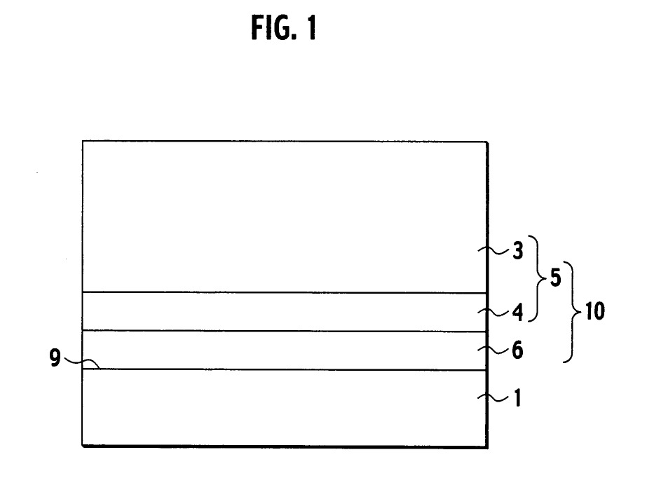

The anodic oxide coating 10 is made of aluminum oxide (alumina) containing silver and/or copper. Specifically, as shown in FIG. 1, the anodic oxide coating 10 is provided on a base material 1 made of an aluminum alloy, and includes: a porous layer 5 located on a front surface side of the base material 1 and formed of a growth layer 3 and a barrier layer 4; and a permeation layer 6 present between the porous layer 5 and the base material 1. Then, the growth layer 3 means a porous layer grown from the front surface of the base material 1, the barrier layer 4 means a porous layer permeating an inside of the base material 1, and further, the permeation layer 6 means a nonporous layer appearing between the base material 1 and the porous layer 5.

Then, it is desirable to set a thickness of the anodic oxide coating 10 at approximately 2 to 100 μm. When the thickness of the anodic oxide coating is less than 2 μm, an effect by forming the anodic oxide coating is not exerted sufficiently. Meanwhile, when the thickness of the anodic oxide coating exceeds 100 μm, coating property of following the base material 1 is deteriorated, sometimes causing a coating breakage.

Moreover, it is desirable that silver and copper which are additive components for enhancing heat conductivity of the anodic oxide coating be unevenly distributed to some extent or more in the vicinity of an interface with the aluminum alloy base material. Specifically, as shown in FIG. 1, it is preferable that a content of these metals in a range of at least 1 μm from the interface 9 between the anodic oxide coating 10 and the base material 1 be set at 2% by mass or more in total. In such a way, a heat barrier in the interface between the anodic oxide coating and the base material is absorbed, and the heat conductivity can be thereby enhanced. Meanwhile, when the content of the metals in the vicinity of the interface exceeds 30% by mass, there is a possibility that a peel strength of the interface may be decreased, and accordingly, it is desirable that an upper limit of the concentration of these metals be set at 30% by mass. Specifically, in the present invention, it is desirable to unevenly distribute silver or copper, or both thereof by 2 to 30% by mass in the anodic oxide coating in the range of at least 1 μm from the interface 9 with the aluminum alloy base material. Note that the content of the metals in the anodic oxide coating as described above can be obtained, for example, by an electron probe X-ray microanalyzer (EPMA).

Note that, in order to allow the vicinity of the interface of the anodic oxide coating to contain silver and copper, first, an anodizing using an electrolysis solution which does not contain ions of these metals is performed. Thereafter, another anodizing is implemented in an electrolysis solution containing the silver and copper ions. In such a way, silver and copper can be contained.

Moreover, as the aluminum alloy coated with the anodic oxide coating of the present invention, any alloy can be used as long as the alloy can be applied to the engine part as described above, such as the piston, the intake/exhaust valves, the cylinder head, the cylinder block, the compressor housing, the piston rings, and the oil pan. However, the AC8A material in the JIS standard is particularly preferable.

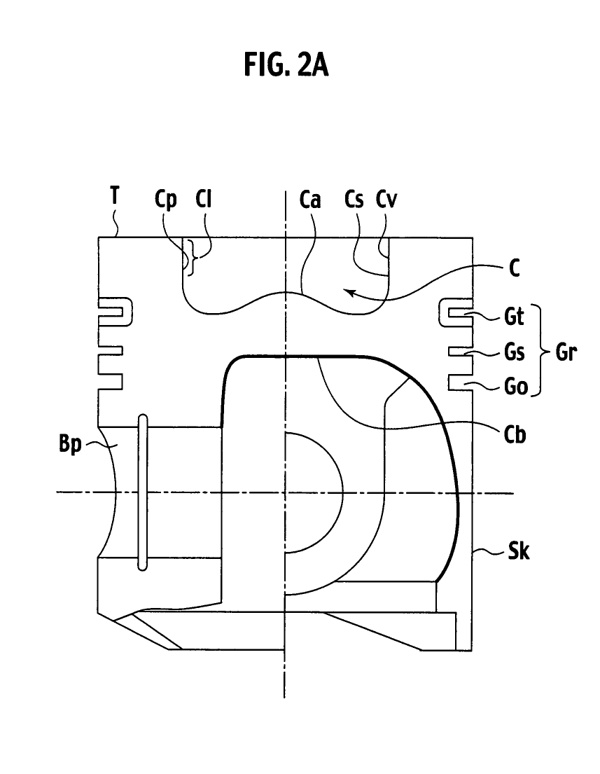

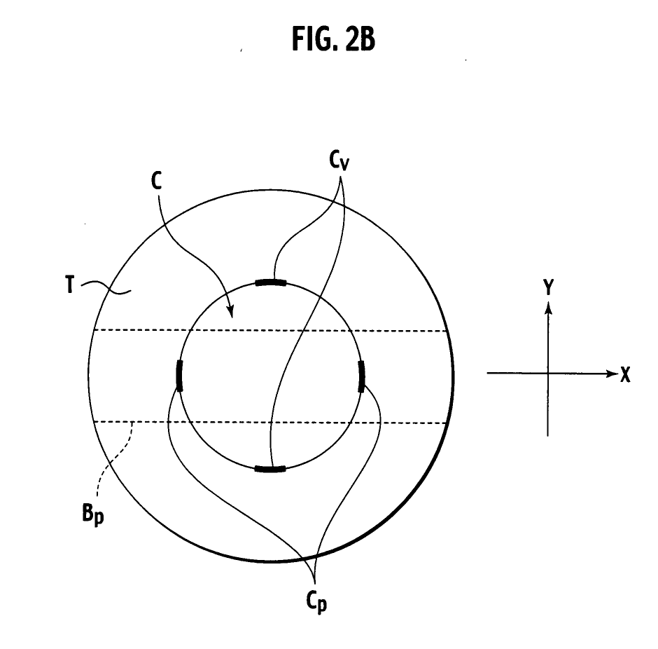

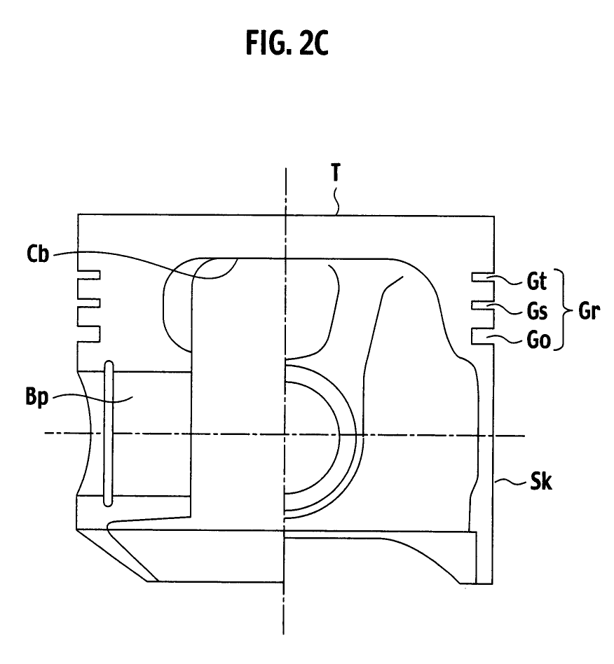

FIG. 2A is a cross-sectional view showing a structure of a piston for a diesel engine, as an example of the aluminum alloy-made part. The piston for a diesel engine forms a cylindrical shape, in which a shallow piston cavity C is provided on a piston top T.

The piston cavity C is composed of a bottom surface Ca and a side surface Cs thereof. Then, an upper end of the side surface Cs of the piston cavity C is referred to as a lip Cl. As shown in FIG. 2B, the lip Cl in the side surface Cs of the piston cavity C includes vertical lips Cv as substantially parallel surfaces to an insertion direction X of a piston pin into a piston pin boss Bp, and pin-direction lips Cp as substantially parallel surfaces to a direction Y perpendicular to the insertion direction X of the piston pin.

Then, a back side of the piston is formed as a piston top back Cb. Note that, in this specification, the piston top back Cb refers to an inner surface of the piston, and a range thereof extends to a piston skirt Sk. Specifically, the piston top back Cb is shown by a range drawn by a bold line in FIG. 2A.

Moreover, on an upper portion of a side surface of the piston, a piston ring groove Gr is formed, which is composed of a top ring groove Gt, a second ring groove Gs, and an oil ring groove Go. Piston rings are adapted to be fitted to these respective grooves. A lower side of the piston ring groove Gr is formed as the piston skirt Sk. Moreover, the piston pin boss Bp into which the piston pin for coupling a connecting rod (not shown) to the piston is inserted is formed in a state of penetrating the piston skirt Sk.

Meanwhile, FIG. 2C is a cross-sectional view showing a structure of a piston for a gasoline engine, as another example of the aluminum alloy-made part. The piston concerned forms a cylindrical shape substantially similar to the above-described piston for a diesel engine except that the piston has a flat piston top without the piston cavity.

The aluminum alloy-made part of the present invention can be applied to the piston as described above. In this case, it is desirable to form the anodic oxide coatings of the present invention particularly on a piston top T, a piston top back Cb, a piston ring groove Gr, or two or more of these regions among the respective regions of the piston. In such a way, on the piston top T, a heat crack can be restricted, and heat absorption from a combustion chamber can be enhanced. Moreover, on the piston top back Cb, heat exhaustion to engine oil can be promoted. Further, on the piston ring groove Gr, adhesion resistance and heat transfer to the piston rings can be enhanced. In such a way, it becomes possible to make reliability of the part and cooling performance for the combustion chamber compatible with each other.

Moreover, the anodic oxide coatings as described above can be formed also on regions of the piston, which exclude the piston skirt Sk and an inner circumferential surface of the piston pin boss Bp. In such a way, promotion of heat purge from the portions other than the above-described piston top T, piston top back Cb, and piston ring groove Gr can be realized without damaging slidability of the piston. Note that, in the case of forming the anodic oxide coatings on the piston skirt Sk and the inner circumferential surface of a piston pin boss Bp, though an effect of cooling the combustion chamber is expected, such formation adversely affects the slidability, sometimes resulting in an increase of friction, and seizure.

Moreover, as for areas of the piston top T and the piston top back Cb, which are subjected to the anodizing, it is desirable that the anodic oxide coatings be formed on 60% or more of the area of the entire piston top and 80% or more of the area of the entire piston top back. One or both of the piston top and the piston top back satisfy such conditions, thus making it possible to effectively obtain the cooling performance for the combustion chamber. When the area of the anodic oxide coating on the piston top does not reach 60% of the entire area of the piston top, heat input from the combustion chamber becomes insufficient, and accordingly, there is a possibility that the cooling performance for the combustion chamber may become insufficient. Moreover, when the area of the anodic oxide coating on the piston top back does not reach 80% of the entire area of the piston top back, the heat exhaustion to the oil becomes insufficient, and the cooling performance for the combustion chamber thereby tends to be insufficient.

By implementing the anodizing in the above-described manner, a tensile stress remains on the interface between the anodic oxide coating and the base material. As in the piston for a diesel engine, in the case where the lip is provided on the piston top, and a large tensile stress occurs in the direction Y perpendicular to the insertion direction of the piston pin in the lip, the tensile stress becomes larger if the anodic oxide coatings are present on the regions concerned (pin-direction lips), resulting in contribution to the heat crack on the contrary. Hence, it is desirable to form the anodic oxide coatings except on the pin-direction lips Cp in the piston cavity in such manner that the anodizing is implemented except for the regions concerned in the case of the anodizing implemented for the piston top. In such a way, the crack owing to the tensile stress caused in such the anodic oxide coating in the pin-direction lips Cp can be prevented from occurring.

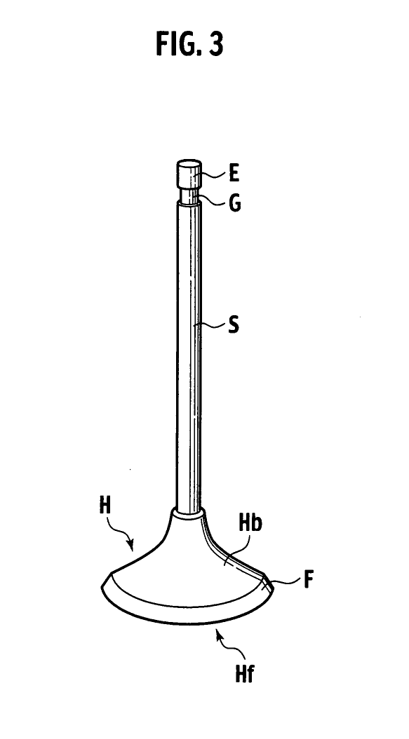

FIG. 3 is a perspective view showing a basic structure of an intake valve for an internal combustion engine, as another example of the aluminum alloy-made part. The intake valve is composed of a shaft-like stem S and an umbrella member H. On a position of the stem S, which is close to a shaft end E, a cotter grove G which receives a cotter for fixing a retainer engaging a valve spring is formed. The umbrella member H includes an umbrella front Hf facing to the combustion chamber of the engine, an umbrella back Hb facing to an intake manifold side, and a valve face F formed to be conical on an outer circumference of the umbrella back Hb and brought into intimate contact with a valve seat.

The aluminum alloy-made part of the present invention can also be applied to the intake valve as described above. In this case, in the intake valve formed of an aluminum material having high heat conductivity, the anodic oxide coatings containing silver and/or copper which have high thermal emissivity and heat conductivity can be formed on the umbrella front, the umbrella back, or both thereof. In such a way, a drawback of the conventional anodic oxide coating that the heat conductivity is low though the heat radiation property is originally excellent can be overcome, and the anodic oxide coating can be formed into an excellent one in heat radiation property and heat conductivity. Moreover, heat input (heat absorption) from the umbrella front and heat radiation from the umbrella back are promoted, the heat radiation from the combustion chamber through the intake valve is made active, and a temperature in the combustion chamber is decreased, thus making it possible to achieve an improvement in a fuel consumption of the internal combustion engine.

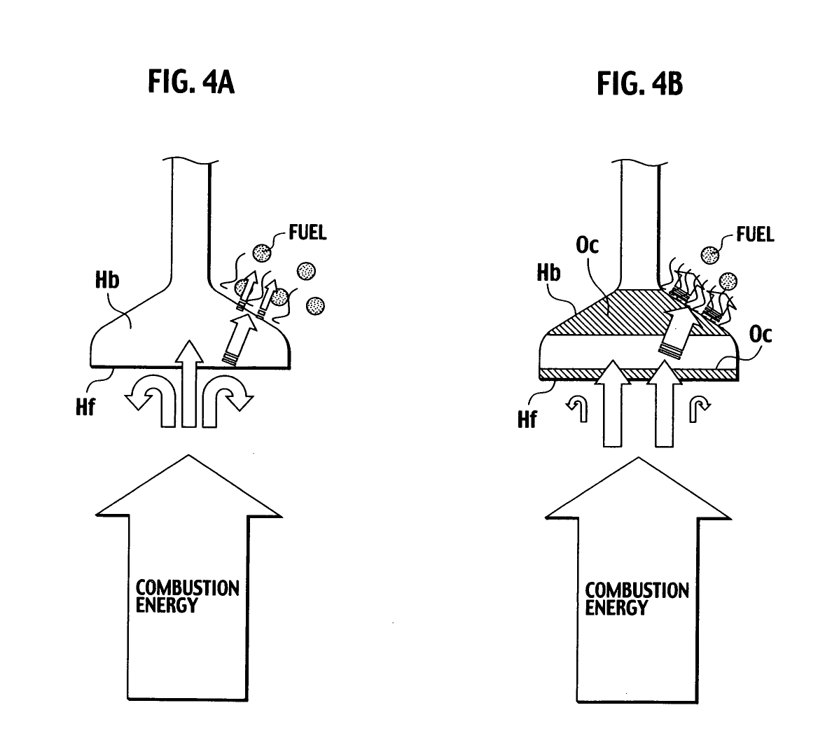

FIG. 4A shows a status where heat is transferred in the conventional intake valve made of an untreated aluminum alloy. FIG. 4B shows a status where heat is transferred in the intake valve of the present invention, in which the anodic oxide coatings containing silver and copper are formed on the umbrella front and the umbrella back. As shown in FIG. 4A, in the untreated intake valve, the thermal emissivity in the umbrella front Hf is low. Accordingly, much of combustion energy generated in the combustion chamber is reflected on the umbrella front Hf, and the intake valve can hardly absorb the combustion energy. Therefore, though heat conduction in the umbrella member is good, the heat radiation from the umbrella back Hb becomes very little since the thermal emissivity from the umbrella back Hb is also low.

As opposed to this, in the intake valve of the present invention, the anodic oxide coatings Oc containing silver and copper and being excellent in heat radiation property and heat conductivity are formed on the umbrella front Hf and the umbrella back Hb. Therefore, as shown in FIG. 4B, the intake valve can absorb much of the combustion energy through the anodic oxide coating Oc formed on the umbrella front Hf. Moreover, the combustion energy is conducted smoothly through the umbrella member, and a large amount of the combustion energy is emitted through the anodic oxide coating Oc of the umbrella back Hb.

In each of the anodic oxide coatings, silver and/or copper are unevenly distributed in the interface with the aluminum base material. It is desirable that average thermal emissivities of the umbrella front and umbrella back of the intake valve on which the anodic oxide coatings are formed be 0.5 or more. In such a way, evaporation of fuel can be promoted, and the fuel consumption can be improved to a large extent. It is more desirable that the average thermal emissivities be set at 0.7 or more. In such a way, the evaporation of the fuel can be promoted, the temperature in the combustion chamber can be decreased by latent heat of evaporation in this case, and a large effect of improving the fuel consumption can be obtained. Note that the term “average thermal emissivity” means a rate of an infrared radiation spectrum with a black body according to JIS R1801, which can be measured by means of a Fourier transform infrared spectrometer (FTIR). Moreover, the average thermal emissivity of each anodic oxide coating can be adjusted by thickening the coating and blackening the coating. The coating can be blackened by increasing a degree of alloy of the base material.

Note that, as described above, it is desirable that silver and copper which are added for the purpose of enhancing the heat conductivity of the anodic oxide coating be unevenly distributed in the vicinity of the interface between the anodic oxide coating and the base material. In such a way, the heat barrier in the interface between the anodic oxide coating and the base material is absorbed, and the heat conductivity of the intake valve can be thereby enhanced.

In the intake valve, similar anodic oxide coatings can be formed on the shaft end E, the valve face F, the stem S, or the cotter groove G, or a plurality of these, and further, on the entirety of the intake valve according to needs in addition to the above-described umbrella front Hf and the umbrella back Hb. In such a way, the abrasion resistance and adhesion resistance of these sliding regions can be enhanced.

Moreover, as described above, the anodic oxide coating of the present invention includes: the porous layer 5 located on the front surface side of the base material I and formed of the growth layer 3 and the barrier layer 4; and the permeation layer 6 present between the porous layer 5 and the base material 1. Among them, the growth layer 3 is a porous one as compared with the dense barrier layer 4, and tends to be abraded more than the barrier layer 4, and further, abraded powder thereof functions as abrasive grains. Therefore, as for the anodic oxide coatings formed on the shaft end E, the valve face F, the stem S, and the cotter groove G, which are described above, it is desirable to remove the growth layers 3 thereof in advance and to retain the barrier layers 4 and the permeation layers 6. In such a way, the abraded powder at the time of initial abrasion of the intake valve is reduced, thus making it possible to absorb the attack to the sliding regions from the alumina.

A description will be made below in more detail of the present invention by examples; however, the present invention is not limited only to these examples.

Note that, in Examples 1 to 3, raw workpieces of the pistons for the gasoline engines, which have a shape shown in FIG. 2, were used. For the raw workpieces, the AC8A alloy material subjected to the T6 treatment (subjected to an artificial aging after a solution treatment) was used.

### EXAMPLE 1

For a plurality of the raw workpieces of the pistons for the gasoline engine, first, masking was implemented other than the piston top backs Cb. Thereafter, in dilute sulfuric acid as an electrolysis solution, the anodizing was implemented for the raw workpieces for 20 minutes by using a direct current with a current density of 5 A/dm². Moreover, in dilute sulfuric acid containing silver of 15 g/L as an electrolysis solution, an alternating voltage of 13 to 20V was applied to the raw workpieces for 0 to 20 minutes. In such a way, the plurality of pistons on which the anodic oxide coatings with a thickness of 50 μm were formed were fabricated. In this case, the silver contents of the respective anodic oxide coatings were differentiated from one another. The average thermal emissivity of the surface of each anodic oxide coating was measured by means of the FTIR, and then a resultant value thereof was 0.86. Moreover, the silver content in the range of 1 μm from the interface between each anodic oxide coating and each base material was measured by means of the EPMA. As a result, it was confirmed that the plurality of pistons in which silver of 0 to 35% by mass was unevenly distributed were obtained. Furthermore, in the case of the pistons containing silver in the anodic oxide coatings, it was confirmed that the layers containing silver were thickened to 5 μm.

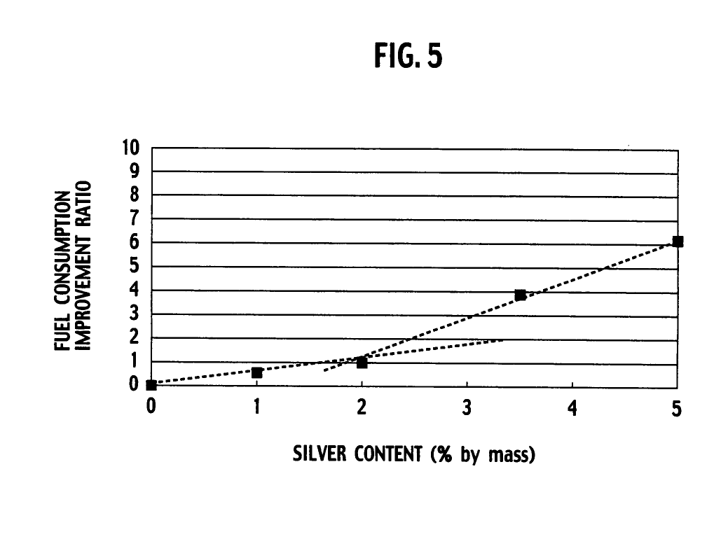

As described above, in the pistons, the anodizing was implemented only for the piston top backs Cb, and the silver contents on the interfaces between the anodic oxide coatings and the base materials were varied from one another. The pistons described above were individually assembled to the engines. Then, performance tests were conducted for the engines in such a manner that the engines were continuously operated individually for 1 hour while setting the number of revolutions of the engines at 1200 rpm, 2000 rpm, 4000 rpm, and 6400 rpm. In such a way, there were investigated the effects of improving the fuel consumption, which were based on the cooling of the combustion chambers, in the case of forming the anodic oxide coatings. Results of the investigation are shown in FIG. 5. Note that an axis of ordinates in FIG. 5 represents relative values of a fuel consumption improvement when a fuel consumption improvement ratio in the case where the silver content in the range of 1 μm from the interface is 2% by mass is “1”.

From FIG. 5, it is understood that the fuel consumptions of the engines were improved in a range where the silver contents were 2% by mass or more owing to the fact that the combustion chambers were cooled. This is considered to result from that the heat barrier in the interface between each anodic oxide coating and each base material was absorbed more to promote the heat transfer more as the silver content was being increased.

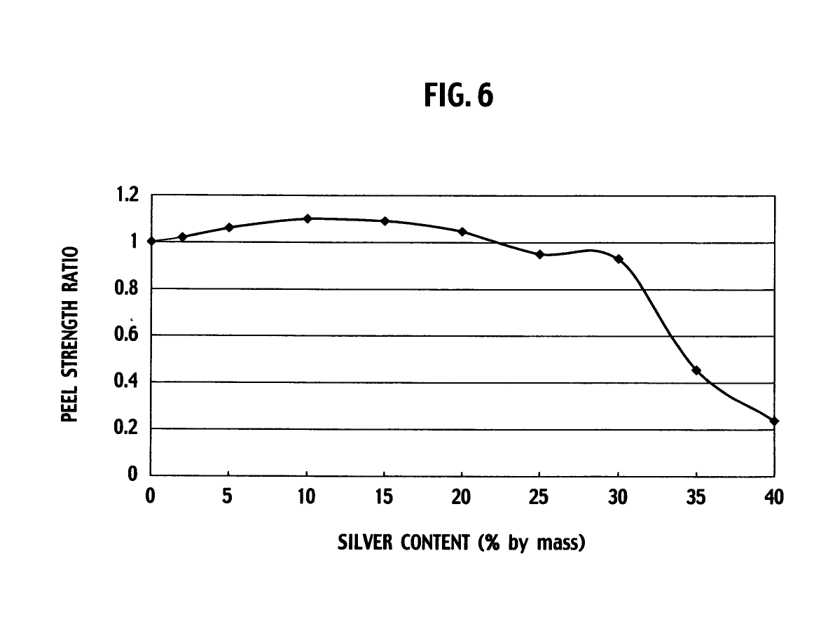

Note that, as the silver content is being increased, a further effect of enhancing the heat transfer is expected. However, the anodic oxide coating is required to be peel-resistant in each sliding region. Therefore, as shown in FIG. 6, it is recognized that a silver content up to 30% by mass is a suitable silver content where the decrease of the peel strength is not observed.

Note that values of FIG. 6 were obtained in accordance with JIS H 8682-1. A ratio of loads applied to the coating and the base material, where grain boundary decohesion occurs therebetween in an abrasive wheel wear test, was defined as a peel strength ratio.

### EXAMPLE 2

For a plurality of the raw workpieces of the pistons for the gasoline engine, first, masking was implemented for portions which did not require the anodic oxide coatings. Thereafter, in dilute sulfuric acid as an electrolysis solution, the anodizing was implemented for the raw workpieces for 20 minutes by using a direct current with a current density of 5 A/dm². Moreover, in dilute sulfuric acid containing silver of 15 g/L as an electrolysis solution, an alternating voltage of 14V was applied to the raw workpieces for 4 minutes. In such a way, there were individually fabricated a piston in which the coating was formed on the piston top T, a piston in which the coating was formed on the piston top back Cb, a piston in which the coating was formed on the top ring groove Gt of the piton ring groove Gr, a piston in which the coating was formed on the entirety of the piston ring groove Gr, and a piston in which the coating was formed on the entire surface excluding the piston skirt Sk and the inner circumferential surface of the piston pin boss Bp. Note that a thickness of each anodic oxide coating was 50 μm. Moreover, average thermal emissivity of a surface of each anodic oxide coating was 0.86. Furthermore, a silver content in the range of 1 μm from the interface between each anodic oxide coating and each base material was measured by means of the EPMA. As a result, it was confirmed that silver of 2% by mass was unevenly distributed there.

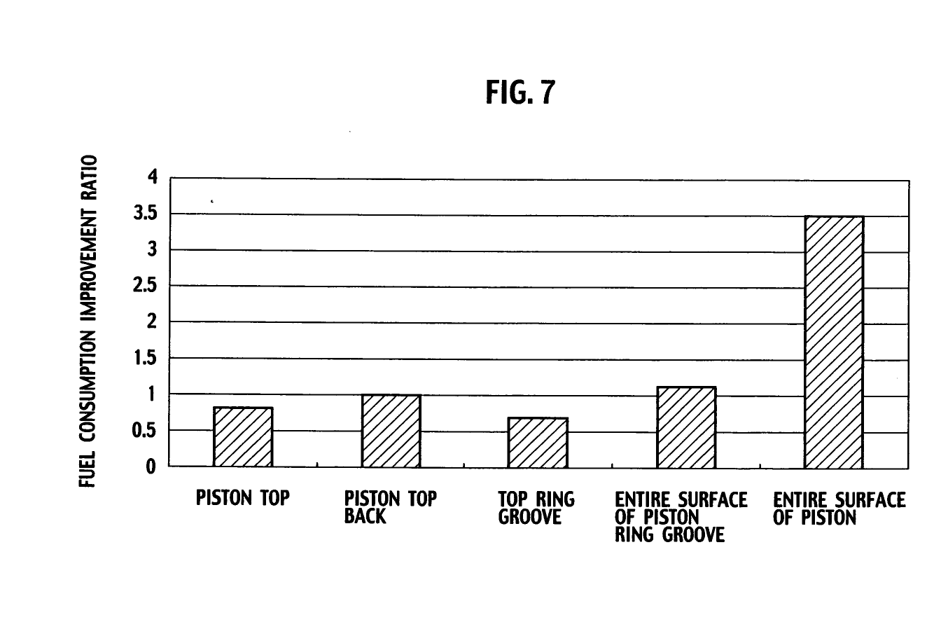

The pistons in which the anodizing was implemented for the respective portions were individually assembled to the engines. Then, similar performance tests to those of Example 1 were conducted, and there were investigated the effects of improving the fuel consumption, which were based on the cooling of the combustion chambers by the anodic oxide coatings formed on the respective portions of the pistons. Note that, in this case, these resultant effects were compared with that in an anodic oxide coating that did not contain silver on the interface. Results are shown in FIG. 7.

As obvious from FIG. 7, it is understood that, when the anodic oxide coatings were formed on the piston top T, the piston top back Cb, the top ring groove Gt, and the entire surface of the piston ring groove Gr, all these cases contribute to the improvement of the fuel consumption, which is brought by cooling the combustion chambers. Specifically, the piston top T realizes the promotion of the heat absorption from the combustion chamber, the piston top back Cb realizes the promotion of the heat exhaustion to the engine oil, and the piston ring groove Gr realizes the promotion of the heat transfer to the piston rings, all of which contribute to the cooling of the combustion chambers. Moreover, in the piston ring groove Gr, when the anodic oxide coating is formed on the top ring groove Gt present on the highest temperature side, the effect of cooling the combustion chamber can be made more effective.

Moreover, when the anodizing was implemented for the entire surface excluding the piston skirt Sk and the piston pin boss Bp, a further effect of improving the fuel consumption can be obtained. This is because silver present on the interface between the anodic oxide coating and the base material forms a path of the heat, which promotes the heat transfer in the part. In this case, also when the anodic oxide coatings are formed on the piston skirt Sk and the piston pin boss Bp, the effect of cooling the combustion chamber is expected. However, such formation adversely affects the slidability when the engine is operated, resulting in the increase of friction and the seizure. Accordingly, the piston skirt Sk and the piston pin boss Bp were excluded from the regions to be treated.

### EXAMPLE 3

For a plurality of the raw workpieces of the pistons for the gasoline engine, masking was implemented for portions other than the piston tops T or the piston top backs Cb. Moreover, for the piston tops T and the piston top backs Cb, masking areas were varied individually. Thereafter, in dilute sulfuric acid as an electrolysis solution, the anodizing was implemented for the raw workpieces for 20 minutes by using a direct current with a current density of 5 A/dm². Moreover, in dilute sulfuric acid containing silver of 15 g/L as an electrolysis solution, an alternating voltage of 14V was applied to the raw workpieces for 4 minutes. In such a way, seven types of the pistons in which areas of the anodic oxide coatings on the piston tops T and the piston top backs Cb were different from one another were fabricated. Note that a thickness of the anodic oxide coating of each piston was 50 μm, and average thermal emissivity of a surface of each anodic oxide coating was 0.86. Furthermore, a silver content in the range of 1 μm from the interface between each anodic oxide coating and each base material was measured by means of the EPMA. As a result, it was confirmed that silver of 2% by mass was unevenly distributed there.

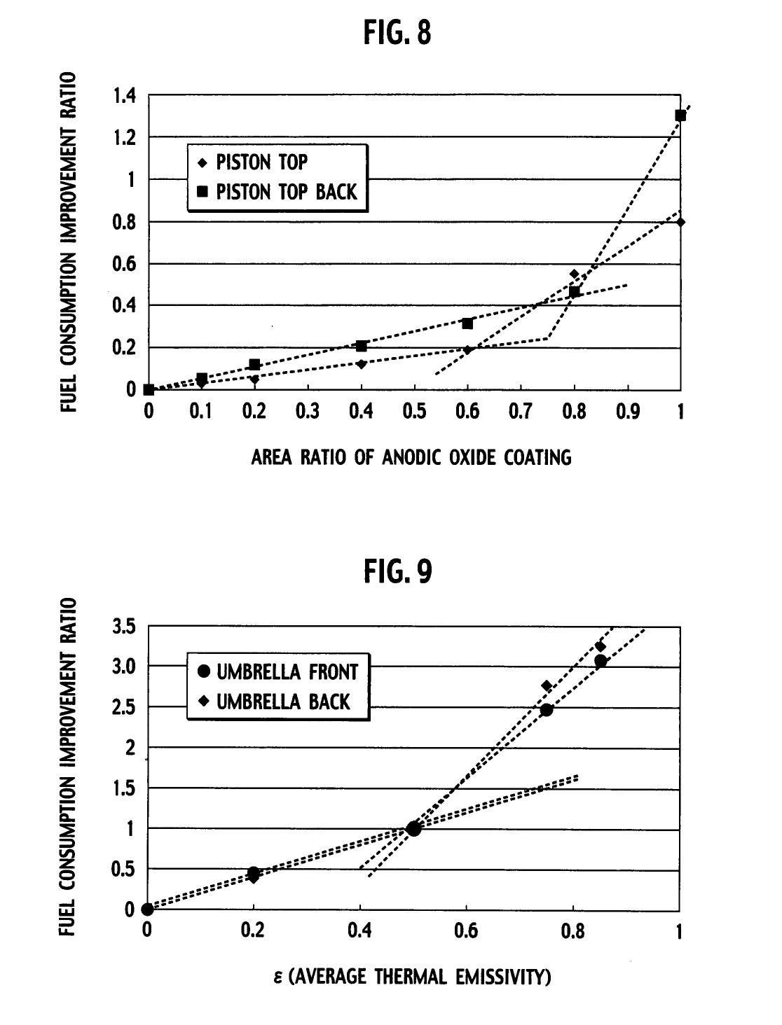

Pistons were prepared, in which the anodizing was implemented only for the piston tops T, and a ratio a (a=area of anodic oxide coating of piston top/entire area of piston top) of the area of each anodic oxide coating to the entire area of each piston top was varied in a range of 0 to 1. Moreover, pistons were prepared, in which the anodizing was implemented only for the piston top backs Cb, and a ratio b (b=area of anodic oxide coating of piston top back/entire area of piston top back) of the area of each anodic oxide coating to the entire area of each piston top back was varied in a range of 0 to 1. Then, these pistons were individually assembled to the engines, similar performance tests to those of Example 1 were conducted, and the effects of improving the fuel consumption, which were based on the cooling of the combustion chambers, were investigated. Results are shown in FIG. 8. Note that, in this case, these resultant effects were compared with that in the anodic oxide coating that did not contain the silver on the interface.

As obvious from FIG. 8, it is understood that, in ranges of a≧0.6 or b≧0.8, the heat transfer in the inside of the piston is promoted, the combustion chamber is cooled, and the fuel consumption is thereby improved.

In Examples 4 to 8, raw workpieces of intake valves for an internal combustion engine, each of which had the shape shown in FIG. 3, were used. Each raw workpiece was fabricated by using rapidly solidified aluminum powder, and dimensions of each raw workpiece are as follows.

Diameter of stem: 5.5 mm

Length of stem: 90.2 mm

Diameter of umbrella member: 133.8 mm

Height of umbrella member: 14.5 mm

### EXAMPLE 4

For a plurality of the workpieces of the intake valves, first, in dilute sulfuric acid as an electrolysis solution, the anodizing was implemented for the raw workpieces for 30 minutes by using a direct current with a current density of 4 A/dm². Thereafter, in dilute sulfuric acid containing silver of 15 g/L as an electrolysis solution, an alternating voltage of 14V was applied to the raw workpieces for 4 minutes. In such a way, the intake valves in which the anodic oxide coatings with a thickness of 50 μm were formed on the umbrella members were fabricated. The average thermal emissivity of the surface of each anodic oxide coating was measured by means of the FTIR, and then a resultant value thereof was 0.86. Moreover, it was confirmed by the EPMA that silver of 2.0% by mass was unevenly distributed in the range of 3 μm from the interface between each anodic oxide coating and each base material, and no silver was observed in other regions.

In this case, such sample workpieces were divided into a group of the ones in which the anodic oxide coatings were formed only on the umbrella fronts and a group of the ones in which the anodic oxide coatings were formed only on the umbrella backs. Moreover, masking was partially implemented for the respective umbrella fronts and umbrella backs, masking areas were varied, and the average thermal emissivities of the umbrella fronts and the umbrella backs were varied individually.

The respective intake valves having such different average thermal emissivities, in which the anodizing was implemented for the umbrella fronts and the umbrella backs, were individually assembled to the engines. Then, performance tests were conducted for the engines in such a manner that the engines were continuously operated individually for 1 hour while setting the number of revolutions of the engines at 1000 rpm, 2000 rpm, 4000 rpm, and 6000 rpm. In such a way, for the intake valves in which the anodic oxide coatings were formed on the umbrella fronts and the umbrella backs, there were investigated influences of the average thermal emissivities to variation rates of the effects of improving the fuel consumption, which were brought by promoting atomization of the fuel. Results of the investigation are shown in FIG. 9. Note that an axis of ordinates in FIG. 9 represents relative values of the fuel consumption improvement when a fuel consumption improvement ratio in the case where the average thermal emissivity is 0.5 is “1”. Moreover, values of the intake valves in which the anodic oxide coatings were formed only on the umbrella fronts are shown by marks, and values of the intake valves in which the anodic oxide coatings were formed only on the umbrella backs are shown by ♦ marks.

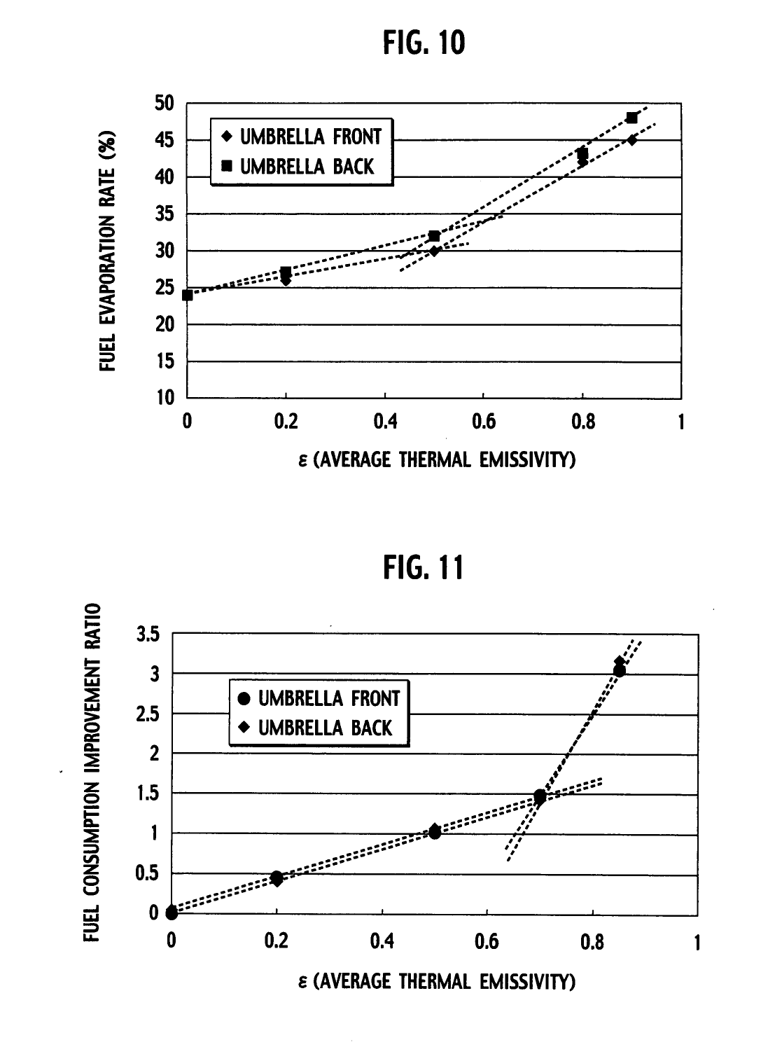

From FIG. 9, it is understood that, also in the intake valves in which the anodic oxide coatings were formed on the umbrella fronts or the umbrella backs, the fuel consumptions are improved owing to the promotion of the atomization in a range where the average thermal emissivities are 0.5 or more. Moreover, as shown in FIG. 10, it is understood that fuel evaporation rates are improved in the range where the average thermal emissivities are 0.5 or more.

### EXAMPLE 5

For the intake valves fabricated in Example 4, similar performance tests to those of Example 4 were conducted. In such a way, for the intake valves in which the anodic oxide coatings were formed on the umbrella fronts or the umbrella backs, there were investigated influences of the average thermal emissivities to variation rates of the effects of improving the fuel consumption, which were brought by promoting the heat purge caused by the latent heat of evaporation. Results of the investigation are shown in FIG. 11. As in FIG. 9, an axis of ordinates in FIG. 11 also represents relative values of the fuel consumption improvement rates when the fuel consumption improvement ratio in the case where the average thermal emissivity is 0.5 is “1”. Moreover, values of the intake valves in which the anodic oxide coatings were formed only on the umbrella fronts are shown by marks, and values of the intake valves in which the anodic oxide coatings were formed only on the umbrella backs are shown by ♦ marks.

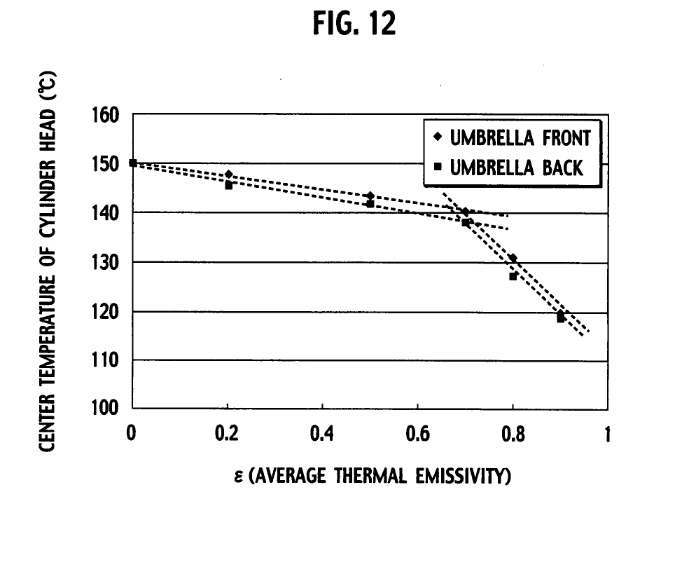

As obvious from FIG. 11, it is understood that, also in the intake valves in which the anodic oxide coatings were formed on the umbrella fronts or the umbrella backs, the fuel consumptions are improved owing to the latent heat of evaporation in a range where the average thermal emissivities are 0.7 or more. Moreover, as shown in FIG. 12, it is understood that a temperature of a center of each cylinder head is decreased owing to an increase of the average thermal emissivity.

### EXAMPLE 6

For a plurality of the workpieces of the intake valves, first, in dilute sulfuric acid as an electrolysis solution, the anodizing was implemented for the raw workpieces for 30 minutes by using a direct current with a current density of 4 A/dm². Thereafter, in dilute sulfuric acid containing silver of 15 g/L as an electrolysis solution, an alternating voltage of 13 to 20V was applied to the raw workpieces for 0 to 20 minutes. In such a way, the plurality of intake valves on which the anodic oxide coatings with a thickness of 50 μm were formed were fabricated. In this case, the silver contents of the respective anodic oxide coatings were differentiated from one another and the anodic oxide coatings were formed only on the umbrella fronts or the umbrella backs. The average thermal emissivity of the surface of each anodic oxide coating was measured, and then a resultant value thereof was 0.86. Moreover, the silver content in the range of 1 μm from the interface between each anodic oxide coating and each base material was measured by means of the EPMA. As a result, it was confirmed that the silver content was varied in a range of 0 to 25% by mass. Moreover, it was confirmed that the layers containing silver were thickened to 5 μm.

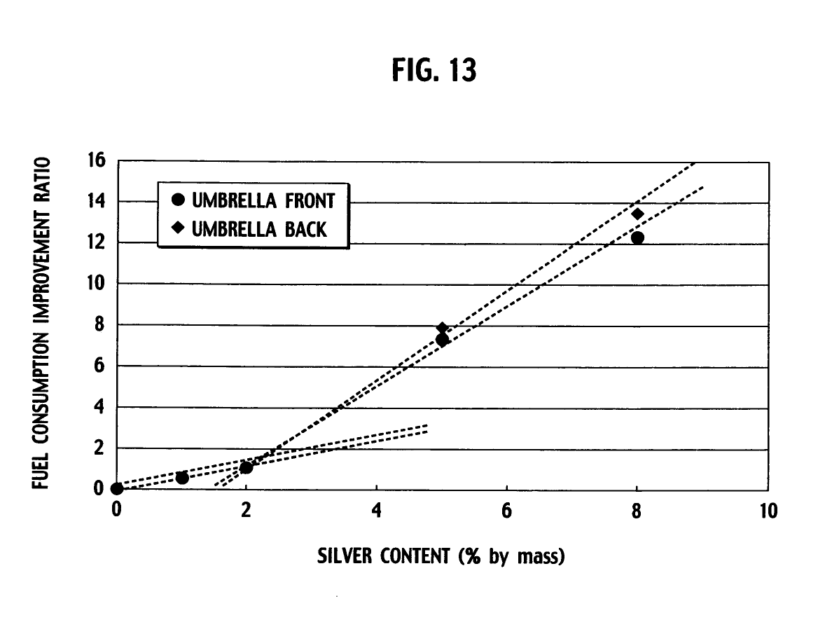

The intake valves in which the anodic oxide coatings different in silver content were formed only on the umbrella fronts or the umbrella backs were individually assembled to the engines. Then, similar performance tests to those of Example 4 were repeated, and influences of the silver contents to the variation rates of the effects of improving the fuel consumption were investigated for the intake valves in which the anodic oxide coatings were formed only on the umbrella fronts and the intake valves in which the anodic oxide coatings were formed only on the umbrella backs. Results of the investigation are shown in FIG. 13. Note that an axis of ordinates in FIG. 13 represents relative values of the fuel consumption improvement rates when a fuel consumption improvement ratio in the case where the silver content is 2% by mass is “1”. Moreover, values of the intake valves in which the anodic oxide coatings were formed only on the umbrella fronts are shown by marks, and values of the intake valves in which the anodic oxide coatings were formed only on the umbrella backs are shown by ♦ marks.

From FIG. 13, it is understood that, also in the intake valves in which the anodic oxide coatings were formed on the umbrella fronts or the umbrella backs, the fuel consumptions are improved in the range where the silver content in the range of 1 μm from the interface between each anodic oxide coating and each base material is 2% by mass or more.

### EXAMPLE 7

Under similar conditions to those of Example 1, first, the anodizing was implemented for a workpiece of the intake valve in dilute sulfuric acid as an electrolysis solution by using a direct current. Thereafter, the anodizing was implemented for the workpiece by using an alternating current in an electrolysis solution containing silver ions. In such a way, the anodic oxide coating was formed to a thickness of approximately 50 μm on the entirety of the intake valve.

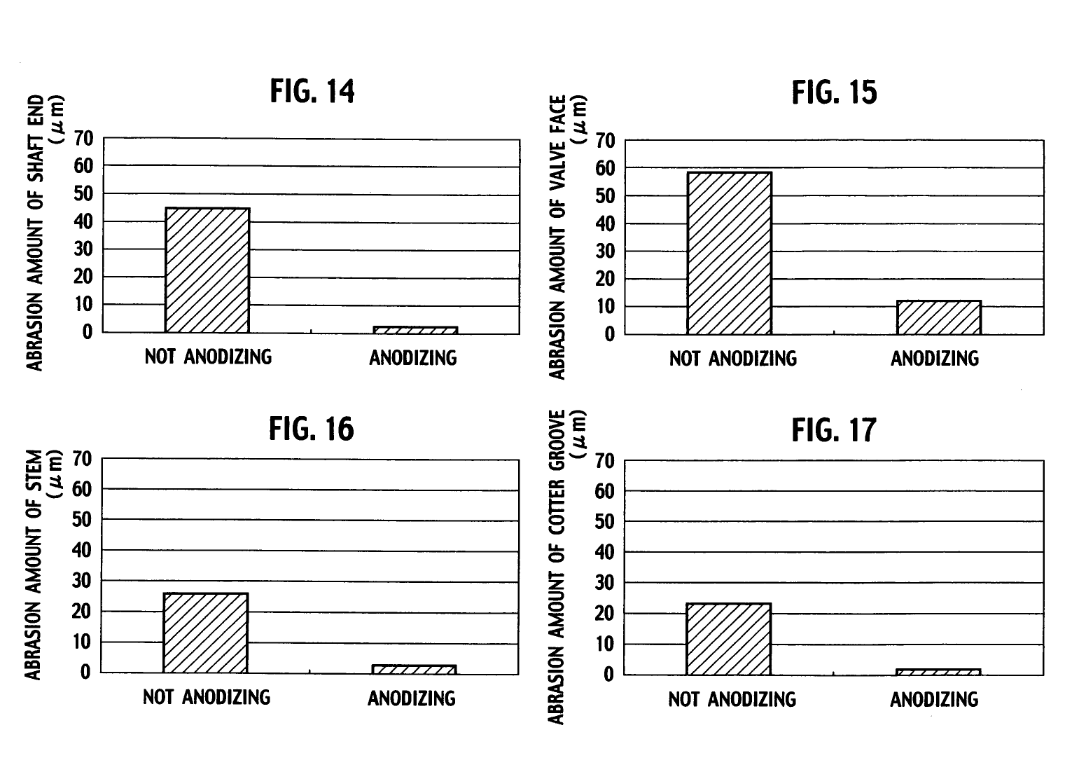

The intake valve fabricated in the above-described manner and an intake valve that was not subjected to the anodizing were individually assembled to the engines. Then, similar performance tests to those of Example 4 were conducted. There were investigated abrasion amounts of the shaft ends E, valve faces F, stems S, and cotter grooves G of the respective intake valves after the tests were ended. Results of the investigation are individually shown in FIGS. 14 to 17.

As obvious from FIGS. 14 to 17, it is considered that hardness and adhesion resistance of the respective portions of the intake valves were enhanced by implementing the anodizing. It is understood that the abrasion amounts after the performance tests were decreased.

### EXAMPLE 8

Under similar conditions to those of Example 7, for a workpiece of the intake valve, a similar anodic oxide coating was formed to a thickness of approximately 50 μm on the entirety of the intake valve. Thereafter, the anodic oxide coating formed on the intake valve concerned was polished by 25 μm as a half thickness of the coating thus formed. In such a way, the growth layer in the anodic oxide coating was removed, and the barrier layer and the permeation layer were retained.

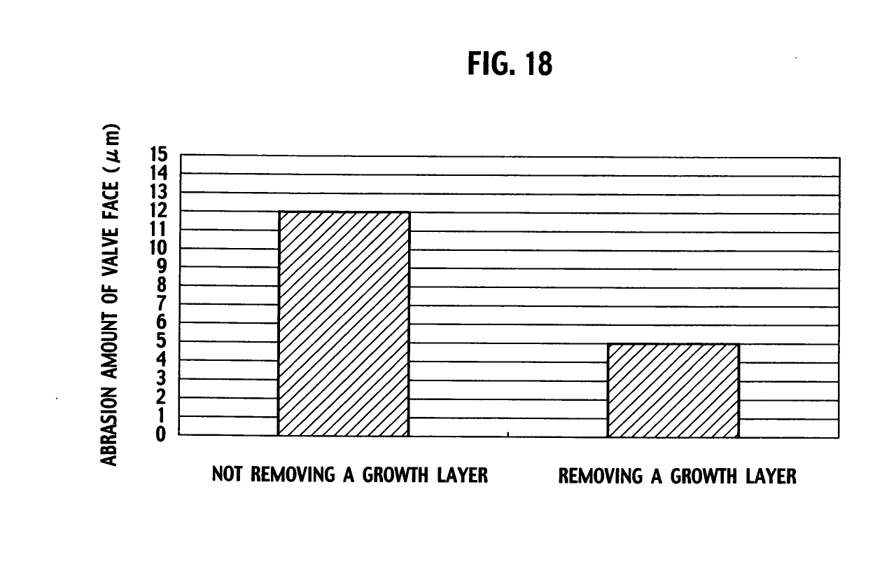

Then, the intake valve thus fabricated, which did not have the growth layer, and an intake valve that was not subjected to the anodic oxide coating polishing were individually assembled to the engines. Thereafter, similar performance tests to those of Example 4 were conducted, and abrasion amounts of the valve faces F in the intake valves after the tests were ended were investigated. Results of the investigation are shown in FIG. 18.

As obvious from FIG. 18, it is understood that the abrasion amount after the performance tests were ended is reduced because, by polishing/removing only the growth layer after the anodizing, a contact pressure is stabilized early, and in addition, alumina powder functioning as the abrasive grains becomes difficult to generate.

Note that, when the barrier layer and the permeation layer are also removed, it is considered that a decrease of surface hardness of the coating occurs, resulting in a deterioration of the abrasion resistance. Moreover, it is considered that such a phenomenon will occur similarly also in the respective sliding regions which are the shaft end E, the stem S, and the cotter groove G.

Note that, though the description has been made of the anodic oxide coatings containing the silver in the respective examples described above, it has been confirmed that similar effects are obtained also in anodic oxide coatings containing copper, which are subjected to an anodizing using copper ions.

Moreover, even if the electrolysis solution containing the silver ions or the copper ions is used from an initial stage of the anodizing, some effects are obtained. Furthermore, it has already been confirmed by the examples that the effect of improving the fuel consumption is observed even if the average thermal emissivity or the silver or copper content is increased a little bit.

The entire contents of Japanese Patent Applications No. P2006-77652 with a filing date of Mar. 20, 2006, No. P2006-77673 with a filing date of Mar. 20, 2006 and No. P2006-342902 with a filing date of Dec. 20, 2006 are herein incorporated by reference.

Although the invention has been described above by reference to certain embodiments of the invention, the invention is not limited to the embodiments described above and modifications may become apparent to these skilled in the art, in light of the teachings herein. The scope of the invention is defined with reference to the following claims.

What is claimed is:

1. An aluminum alloy-made part, comprising:
an aluminum alloy; and
an anodic oxide coating which coats a surface of the aluminum alloy and contains at least one of silver and copper.

2. The aluminum alloy-made part of claim 1,
wherein silver and/or copper are unevenly distributed in a vicinity of an interface between the anodic oxide coating and the aluminum alloy, and silver and/or copper are contained by 2 to 30% by mass in a range of at least 1 μm from the interface between the anodic oxide coating and the aluminum alloy.

3. The aluminum alloy-made part of claim 1,
wherein the aluminum alloy-made part is a piston for an internal combustion engine, and
the anodic oxide coating is provided on at least one region selected from a piston top, piston top back, and piston ring groove of the piston.

4. The aluminum alloy-made part of claim 3,
wherein, in the piston, the anodic oxide coatings are provided on regions other than a piston skirt and an inner circumferential surface of a piston pin boss.

5. The aluminum alloy-made part of claim 3,
wherein following relationships are established:
a≧0.6
and/or
b≧0.8
where a is a ratio of an area of the anodic oxide coating formed on the piston top to an area of the entire piston top, and b is a ratio of an area of the anodic oxide coating formed on the piston top back to an area of the entire piston top back.

6. The aluminum alloy-made part of claim 3,
wherein, on the piston top, the anodic oxide coatings are formed on regions excluding a pin-direction lip in a piston cavity.

7. The aluminum alloy-made part of claim 1,
wherein the aluminum alloy-made part is an intake valve for an internal combustion engine, and
the anodic oxide coating is provided on at least one of an umbrella front and umbrella back of the intake valve.

8. The aluminum alloy-made part of claim 7,
wherein average thermal emissivity of at least one of the umbrella front and the umbrella back is 0.5 or more.

9. The aluminum alloy-made part of claim 7,
wherein average thermal emissivity of at least one of the umbrella front and the umbrella back is 0.7 or more.

10. The aluminum alloy-made part of claim 7,
wherein the anodic oxide coating is provided on at least one selected from the group consisting of a shaft end, a valve face, a stem, and a cotter groove in the intake valve, or on an entire surface of the intake valve.

11. The aluminum alloy-made part of claim 10,
wherein a growth layer of the anodic oxide coating formed on any of the shaft end, the valve face, the stem, and the cotter groove is removed, and a barrier layer and permeation layer of the anodic oxide coating are retained.
